(19) United States
(12) Patent Application Publication
(10) Pub. No.: US 2016/0189134 A1
(43) Pub. Date: Jun. 30, 2016

(54) COLLABORATING USER DEVICES FOR SECURITY

(71) Applicant: EBAY INC., San Jose, CA (US)

(72) Inventors: Michael Voege, San Jose, CA (US); Michael McKay, San Jose, CA (US)

(21) Appl. No.: 14/588,284

(22) Filed: Dec. 31, 2014

(51) Int. Cl. G06Q 20/32

(52) U.S. Cl. CPC G06Q 20/3226; G06Q 20/3278

(57) ABSTRACT

A system and method includes a first device with one or more processors coupled to a memory and reads instructions from the memory to perform the step of receiving a first NFC communication from a master device and enabling payment capabilities of the first device based on the first NFC communications from the master device.

### BACKGROUND

1. Field of the Disclosure

The present disclosure generally relates to device security and more particularly to systems and methods for device security through cooperation by multiple electronic devices.

2. Related Art

As electronic devices have gotten smaller and smaller, more and more everyday objects, such as cellphones and watches, have become computerized and are connected to the Internet. These devices sometimes store payment information, which enable the owner to purchase goods and/or services. These objects are often configured to require the user to perform one or more security functions when activating and/or deactivating the payment capabilities when purchasing goods and/or services. These functions are in place to ensure that the user is truly authorized to use the object for making payments.

However, performing the security functions can be cumbersome. Individuals today have different passwords for every object and it is difficult to remember all of the passwords. Furthermore, entering passwords on small devices also causes problems as the user input mechanisms are limited due to display size and missing keypad capabilities, especially for extra secure passwords that often have over ten letters, numerals, and special characters. Users will often mistype a password and have to retype the password repeatedly. In some cases, the passwords may be short, such as four characters, but then the authentication function would not be very secure.

In some instances, fingerprints are used in place of passwords for convenience. However, fingerprint based security systems have their own flaws. For one, fingerprints may not be as secure as passwords; anything that is touched leaves a copy of a fingerprint and can be lifted by a cunning thief Furthermore, fingerprint scanners have difficulties matching fingerprints, resulting in possible multiple scans. Also, individuals may desire to let a friend borrow a device but have to go through a cumbersome process for deactivating the payment capabilities of the device before handing it over to the other individual.

In any event, current security measures typically require some sort of user action for authentication, even if it is for purchasing a stick of gum for ten cents. A seamless method of providing security would therefore be a desirable solution. Additionally, a simple and easy way of activating and deactivating a user device from functioning as a payment device is also desirable. The embodiments disclosed herein solve these problems and more.

### BRIEF DESCRIPTION OF THE FIGURES

FIG. 1 is a block diagram of an exemplary computing system that is adapted for implementing a system of collaborating user devices for security.

FIG. 2 is a block diagram of an exemplary computer system suitable for implementing one or more devices of the computing system in FIG. 1 and the embodiments in this disclosure.

FIG. 3 illustrates a user with several devices implementing an exemplary security based on collaborating user devices.

FIG. 4 is a flow diagram illustrating an exemplary process for providing security through collaborating devices.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In some embodiments, a system and method for easily deactivating and activating and/or changing authorization of the payment capabilities of a device is disclosed. In some embodiments, activating and/or deactivating the payment capabilities of a device is conducted from a NFC tap of another device, such as a master device. In some embodiments, activating and/or deactivating the payment capabilities may be through another computing device, which may be a master device.

In some embodiments, a system and method implements seamless payment security and authentication. In some embodiments, the system and method flips the current payment security paradigm The current payment security paradigm assumes that the user is unauthorized and requires some sort of authorization to activate payments, e.g. signatures on a receipt, finger print scans, passwords, etc. In some embodiments, the system and method uses the opposite paradigm where payment from a payment device is presumed authorized and one or more actions and/or series of situations deactivates or prevents payments. In this manner, users may make payments with payment devices without performing an authentication action. An authentication action, as described herein, are actions performed by a user in response to a request for authentication and/or proof of identity interrupting a transaction, service, and/or account access. Authentication actions including, but are not limited to, providing a finger print, password, pin number, voice response, signature, and or a combination of requests that is interrupting a transaction, service, and/or account access by a person and/or user device. Authentication actions do not include actions necessary for initially setting up an account, service, and/or a device.

In some embodiments, a system and method maintains authentication on devices for payment using a personal network of several devices associated with the user. For example, a user may have a smartphone, smart watch, smart ring, smart card, smart wallet, and/or other devices on the user. Each device may be capable of paying for goods through near field communications technology. The devices may be part of a personal area network in communications with each other, the presence of the multiple devices each authenticating the other device. For example, a smartphone and a smart watch may be authenticated to make payments while within close enough proximity to be in communications through a personal area network. The smart watch and/or phone may automatically deactivate, be set to an unauthorized state, and/or to a reduced spending limit when the device leaves the proximity of the personal area network.

In some embodiments, there may be authentication levels that are affected by the number of devices in the personal network of the user. For example, a single device may be authorized to make purchases in a low-level price range, two devices may authorize purchases at higher price range, and so forth. In some embodiments, the levels may be user customizable.

In some embodiments, a user may be able to manually disable, de-authorize and/or de-authenticate a device. The action to disable, de-authorize and/or de-authenticate a payment device may be a tap from another payment device, and/or a master device using near field communications (NFC), Bluetooth, Bluetooth Low Energy (BLE), and/or the like. The master device may be designated by the user. In some embodiments the action to disable, de-authorize, and/or de-authenticate a device may be conducted remotely through a network connection. In other embodiments, the master device (such as a ring) may be used (such as by tapping) to authorize or authenticate another user device (such as a phone) to make payments. To disable, de-authorize, and/or de-authenticate the other user device, the master device may again tap the other user device. In some embodiments, there may be a button, virtual button, or an actuatable element that determines whether a tap from the master device disables, de-authorizes, de-authenticates, the other user device. In some embodiments, there may be and LED light on the master device which indicates how a tap from the master device may function. For example a red LED light may indicate a disabling function, while a green LED light may indicate an enabling function. In some embodiments, the other device may have a LED light indicating how it has been affected or the current status of the device. For example, a red LED light may indicate that the object is currently disabled. Such toggling may enable the master device to quickly and easily enable, disable, and/or otherwise change the capabilities of another user device.

In some embodiments, a system and method maintains authentication on devices for payment using biometric signals, input, and/or data from sensors on one or more devices. The devices and systems may be set up such that the biometric signals for authentication, activation, and/or authorization are provided by the user without an authentication action. For example, the biometric signals may be heat, heart rate, blood pressure, and/or the like being collected by sensors on the payment device, such as a ring, watch, glasses, and/or pants, which may be worn by the user. In some embodiments, a user may have a smart ring which could read biometric data while being worn by the user and have the biometric data authorize the user to perform a transaction. In some examples, the biometric data may cause certain limitations, such as spending limitations, on the transaction capabilities of the device.

In some examples, the system may use a combination of biometric signals, which may be continuously collected, periodically collected, and/or automatically collected when necessary (e.g., during a transaction that requires payment authorization). The combination of signals may be unique to the owner and authorizations, activation, and/or authentication may be revoked when the biometrics do not match. In some example, biometric signals may be compared with historic biometric signals that may have been collected at a previous time, such as when the device was set up. In some examples the signals may have been collected while the use performed different activities, such as jogging, shopping at the store, different times of the day, and/or the like.

In some examples, the system may monitor biometric signals of several devices and check for anomalies. For example, a shirt and a ring may detect blood pressure X while a watch may detect blood pressure Y. The system may recognize that the difference in blood pressure between X and Y are sufficiently beyond standard deviations to deactivate, de-authorize, and/or de-authenticate the watch.

In some examples, the security system may use a combination of the personal area network along with the biometric signals for maintaining authorization and/or changing authorization levels.

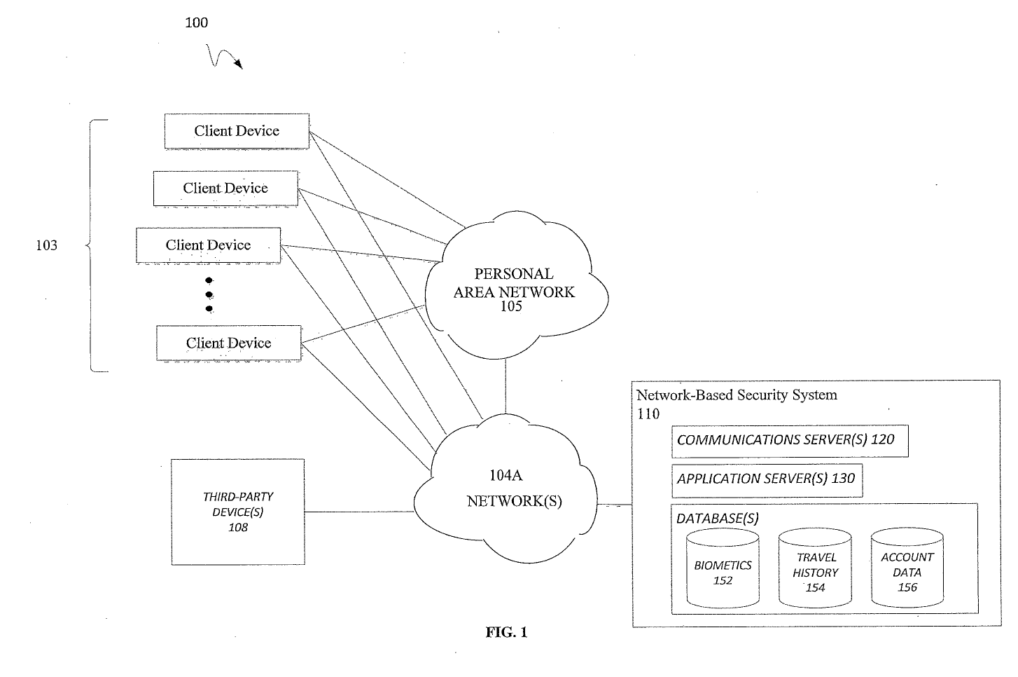

FIG. 1 illustrates an exemplary embodiment of a computing system 100 adapted for implementing a system and method for collaborating multiple user devices for security. As shown, a computing system 100 may comprise or implement a plurality of servers and/or software components that operate to perform various methodologies in accordance with the described embodiments. Exemplary servers may include, for example, stand-alone and enterprise-class servers operating a server operating system (OS) such as a MICROSOFT® OS, a UNIX® OS, a LINUX® OS, or other suitable server-based OS. It may be appreciated that the servers illustrated in FIG. 1 may be deployed in other ways and that the operations performed and/or the services provided by such servers may be combined, distributed, and/or separated for a given implementation and may be performed by a greater number or fewer number of servers. One or more servers may be operated and/or maintained by the same or different entities.

Computing system 100 may include, among various devices, servers, databases and other elements, one or more client devices 103, such as a laptop, a mobile computing device, a tablet, a PC, a wearable device, a cellular telephone, smart phone, smart watch, fitness tracker band, biometric sensors, or other similar mobile devices that a user may carry on or about his or her person and access readily and/or any other computing device having computing and/or communications capabilities in accordance with the described embodiments.

Client devices 103 generally may provide one or more client programs, such as system programs and application programs to perform various computing and/or communications operations. Exemplary system programs may include, without limitation, an operating system (e.g., MICROSOFT® OS, UNIX® OS, LINUX® OS, Symbian OSTM, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), biometric monitoring and sensor applications (e.g. heart rate monitor, heat monitors, pedometers, skin humidity, finger print scanner and/or the like), contacts application, calendar application, electronic document application, database application, media application (e.g., music, video, television), location-based services (LBS) applications (e.g., GPS, mapping, directions, positioning systems, geolocation, point-of-interest, locator) that may utilize hardware components such as an antenna, and so forth. One or more of the client programs may display various graphical user interfaces (GUIs) to present information to and/or receive information from one or more users of client devices 104. In some embodiments, client programs may include one or more applications configured to conduct some or all of the functionalities and/or processes discussed below.

As shown, client devices 103 may be communicatively coupled via one or more networks 104 to a network-based security system 110. Network-based security system 110 may be structured, arranged, and/or configured to allow client devices 103 to establish one or more communications sessions to network-based security system 110. Accordingly, a communications session between client devices 103 and network-based security system 110 may involve the unidirectional and/or bidirectional exchange of information and may occur over one or more types of networks 104 depending on the mode of communication. While the embodiment of FIG. 1 illustrates a computing system 100 deployed in a client-server operating environment, it is to be understood that other suitable operating environments and/or architectures may be used in accordance with the described embodiments.

Communications between client devices 103 and the network-based security system 110 may be sent and received over one or more networks 104 such as the Internet, a WAN, a WWAN, a WLAN, a mobile telephone network, a landline telephone network, as well as other suitable networks. The communications may include part or all of an anonymous and encrypted sensor data which a server may use to identify the user with, and a simple response, such as an indication of yes or no that may indicate authorization of a purchase or not. Any of a wide variety of suitable communication types between client devices 103 and system 110 may take place, as will be readily appreciated. In particular, wireless communications of any suitable form may take place between client device 103 and system 110, such as that which often occurs in the case of mobile phones or other personal and/or mobile devices. In some embodiments, the communications may be encrypted.

In some embodiments, client devices 103 may be owned, managed, or operated by a single entity, such as a person, that may generally be carried and/or worn on or around the user. For example client devices 103 may include a smart watch, smart phone, fitness band, and/or the like. As additional things become computerized and fitted with wireless communications capabilities, such as clothing, jewelry, pace makers, medical band, anklets, bracelets, handcuffs, belts and other wearable objects, these things may also makeup client devices 103. In some embodiments client devices 103 may form a mesh network and/or a personal area network 105. Personal area network 105 may be created using short range wireless communicators such as Bluetooth®, Bluetooth® low energy, wireless infrared communications, wireless USB, Wi-Fi or other wireless technologies for exchanging data over short distances. In some embodiments, one or more of client devices 103 may act as a wireless hotspot for other client devices 103 to connect to one or more networks 104 and communicate with network-based security system 110.

In some embodiments, computing system 100 may include one or more third-party devices 108 which may be communicatively connected to client devices 103 and/or network-based security system 110 through one or more networks 104. Third-party devices 108 may be maintained by a third-party such as a bank, merchant, and/or any other entity. Third-party devices 108 may include ATM machines, payment card processors, servers, and/or the like. In various implementations, third-party devices 108 may be a server that may host applications associated with or employed by a third party. The services may include, but are not limited to, location services, social networking, payment processing, payment verification services, and/or the like.

Network-based security system 110 may comprise one or more communications servers 120 to provide suitable interfaces that enable communication using various modes of communication and/or via one or more networks 108. Communications servers 120 may include a web server, an API server, and/or a messaging server to provide interfaces to one or more application servers 130. Application servers 130 of network-based security system 110 may be structured, arranged, and/or configured to provide various online services such as, payment processing, payment security, payment authorization, device authentication and/or de-authentication, device activation and/or deactivation, account access, account security, identity theft prevention, proof of identity, and/or the like.

In various embodiments, client devices 103 and/or merchant devices 108 may communicate with applications servers 130 of network-based security system 110 via one or more interfaces provided by communication servers 120. It may be appreciated that network-based security system 110 may be structured, arranged, and/or configured to communicate with various types of client devices 104.

Application servers 130, in turn, may be coupled to and capable of accessing one or more databases 150 including, but not limited to, a biometrics database 152, a travel and/or biometric history database 154, and/or account data database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments. In some embodiments, the information held in the databases 150 may be stored on one or more of client devices 103. The data may be held in a distributed fashion and/or in a redundant fashion. In some embodiments, the data may be encrypted for security.

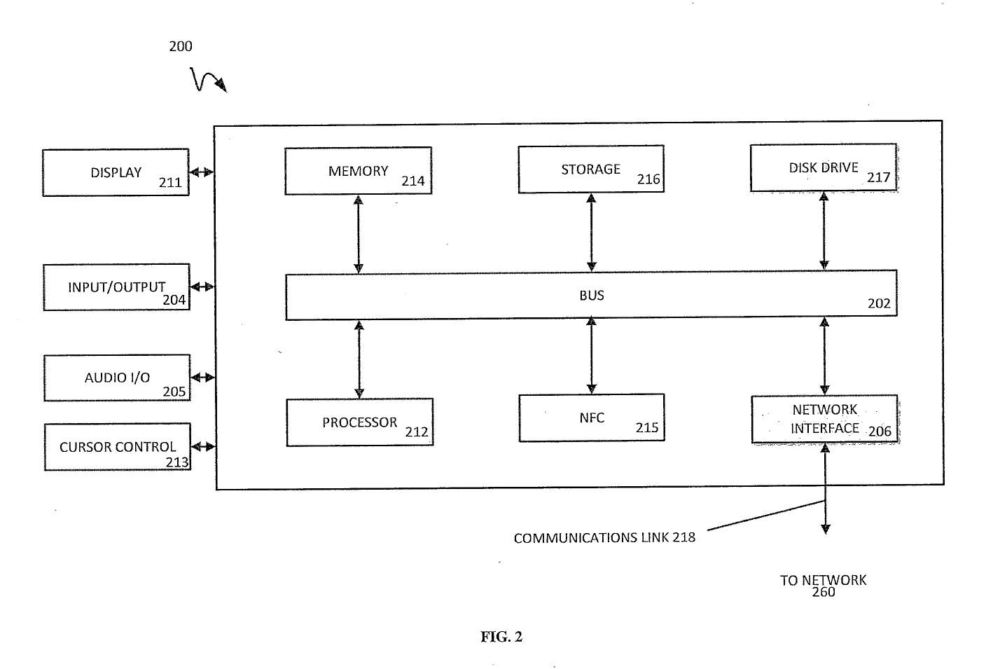

FIG. 2 illustrates an exemplary computer system 200 in block diagram format suitable for implementing on one or more devices of the computing system in FIG. 1 and/or the embodiments discussed herein. In various implementations, a device that includes computer system 200 may comprise a personal computing device (e.g., a smart or mobile phone, a computing tablet, a personal computer, laptop, wearable device, PDA, Bluetooth device, key FOB, badge, etc.) that is capable of communicating with a network. A service provider and/or a payment provider may utilize a network-computing device (e.g., a network server) capable of communicating with the network. It should be appreciated that each of the devices utilized by users, service providers, and payment providers may be implemented as computer system 200 in a manner as follows.

Additionally, as more and more devices become communication capable, such as sensors using wireless communication to report, track, message, encrypt, relay information and so forth, these devices may be part of such transactions. For example, a user may have clothing or jewelry with sensors and gather information such as information from conducting biometric scans. This information may be transmitted through a network connection to the system described herein and/or relayed through a user device.

Computer system 200 may include a bus 202 or other communication mechanisms for communicating information data, signals, and information between various components of computer system 200. Components include an input/output (I/O) component 204 that processes a user action, such as selecting keys from a keypad/keyboard, selecting one or more buttons, links, actuatable elements, etc., and sends a corresponding signal to bus 202. I/O component 204 may also include an output component, such as a display 211 and a cursor control 213 (such as a keyboard, keypad, mouse, touch screen, etc.). An optional audio input/output component 205 may also be included to allow a user to use voice for inputting information by converting audio signals. Audio I/O component 205 may allow the user to hear audio.

Computer system 200 may include a near field communications (NFC) device 215.

NFC device 215, in various embodiments may be positioned as such that it is capable of exchanging data with other devices with NFC technology when placed adjacent to and/or in close proximity to NFC device 215 (this is sometimes referred to as a “tap”). In some embodiments computer system 200 may have an array of NFC devices arranged in rows and columns that span the entirety or part of computer system 200. However, this is merely exemplary and the array of NFC devices may be arranged in any shape and/or may cover a part of computer system 200.

NFC devices 215, in various embodiments, include an NFC transceiver circuitry and/or an NFC antenna. NFC devices may communicate using magnetic fields or electric fields, and may implement standards such as ECMA-340 (NFCIP-1), ECMA-352 (NFCIP-2), ISO/IEC 18092, ISO/IEC 21481, ISO/IEC 14443A, ISO/IEC 14443B, ISO/IEC 15693, JIS X6319-4, and FeliCa. However, it is contemplated that other short-range wireless communication technologies and standards (e.g., radio-frequency identification (RFID), Bluetooth or Bluetooth low energy (BLE), etc.) may be utilized in place of NFC device 215 and fall within the scope of the present disclosure. One of ordinary skill in the art will recognize that the use of near field communication with NFC device 215 may be advantageously utilized to provide for low power communication, and also provide a more secure communication due to its short range.

NFC device 215, in various embodiments, may be configured to detect other devices with NFC technology adjacent to computer system 200, such as when other devices are within the range of NFC device 215 (e.g., within 2 cm, within 5 cm, within 10 cm, within 20 cm, etc.). NFC device 215 may create a communication area for detecting other devices with NFC capabilities. When other devices with NFC capabilities are placed in the communication area of NFC device 215, NFC device 215 may detect the other devices and exchange data with the other devices.

NFC device 215 may receive identifier data packets from the other devices when in sufficiently close proximity. The identifier data packets may include one or more user identifiers, which may be operating system registry entries, cookies associated with a user interface application, identifiers associated with hardware of the other device, or various other appropriate identifiers. The user identifiers may be used to identify the other device, the user of the other device, or a user account associated with the other device, and/or the user itself NFC device 215 may further exchange data and information with the other device.

Computer system 200 may have a transceiver or network interface 206 that transmits and receives signals between computer system 200 and other devices, such as another user device, a merchant server, an email server, application service provider, web server, a social networking server, a payment provider server, and/or other servers via a network. In various embodiments, this transmission may be wireless, although other transmission mediums and methods may also be suitable. A processor 212, which may be a micro-controller, digital signal processor (DSP), or other processing component, processes these various signals, such as for display on computer system 200 or transmission to other devices over a network 260 via a communication link 218. Again, communication link 218 may be a wireless communication in some embodiments. Processor 212 may also control transmission of information, such as cookies, IP addresses, and/or the like to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and/or transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof may be used to implement one or more services, such as the services discussed above and in more detail below.

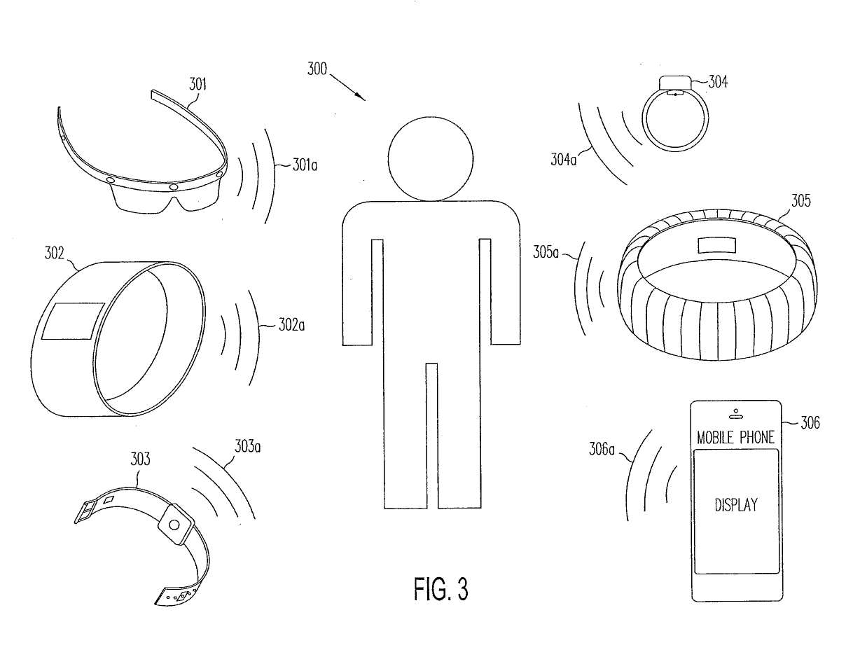

FIG. 3 is an illustration a user 300 with devices 301-306 implementing an exemplary system and method for security based on collaborating user devices. In some examples devices 301-306 may make up client devices 103 of FIG. 1.

In some embodiments, devices 301-306 may be each configured to be a payment capable device. Each device may store keys and/or codes that are related to a payment account for user 300. The keys and/or codes may be unique to each device and may be natively held by non-transitory computer readable media on devices 301-306. For example, devices 301-306 may contain near field communication (NFC) modules for conveying payment information, such as the keys and codes related to a payment account, to other NFC devices to transfer funds and/or pay for goods and services. The payment account may be an account with a payment provider such as a bank, credit card company, PayPal®, merchant, and/or any other financial institution. The payment accounts may be handled by one or more devices such as third-party devices 108 and/or network-based security system 110 of FIG. 1.

In some embodiments, the user may be able to change whether one or more devices 301-306 are authorized to conduct payment transactions. A user may be able to login to a payment account and manually authorize/de-authorize one or more of devices 301-306 for use as a payment device. In some embodiments, devices 301-306 may provide a more convenient method of authorizing and/or de-authorizing one or more devices 301-306 as a payment device. For example, one or more devices 301-306 may have the capability to authorize and/or de-authorize one or more of the devices 301-306 through an NFC. User 300 may, for example, be able to tap mobile phone device 306 on one or more devices 301-305 to enable and/or disable the payment ability of devices 301-305.

In some embodiments, one or more devices 301-306 may be designated as a master device and the other devices as slave or companion devices. The master devices may contain additional functionality, responsibilities, and/or information that the other devices may not have. For example, the ability to authorize and de-authorize another device for use as a payment instrument may be reserved for master devices. In some embodiments, user 300 may be able to choose which devices are set as master devices. In this manner, user may be able to pick a device that user 300 believes is least likely to be stolen and/or lost as the master device (such as a ring or watch) and use it to activate, deactivate, authorize, and/or de-authorize payment capabilities of the other devices (such as a phone).

In some embodiments, slave devices may require a key and/or code from a master device to be used as a payment device. This key and/or code may be provided and/or removed by the master device through NFC communications when the master device taps a slave device. The slave devices may also have a unique key and/or code for itself, and when conducting payments with the slave device, the unique key and/or code and the master key and/or code may be used for authorizing payments. In this manner, user 300 may also be able to remotely de-authorize payments from a slave device by de-authorizing the unique key and/or code of the slave device. In some examples, user 300 may log into an account provided by a payment provider, which may be set up by third-party merchant devices 108 and/or network-based security system 110 of FIG. 1.

In some embodiments, devices 301-306 may create a personal area network using short-range wireless communications 301a-306a. Short-range wireless communications 301a-306a may use a single wireless communication protocol, such as Bluetooth® or BLE. In some embodiments, wireless communications 301a-306a may use multiple communication protocols, such as Bluetooth® and Wifi. Some devices may use one protocol, some devices may use another protocol, and some devices may use multiple protocols. Each of devices 301-306 may be configured to recognize and automatically connect with each other when in range of wireless communications 301a-306a. In some embodiments, the personal area network may implement a security code, such that devices may only connect with the correct security key. In some embodiments, security may be established through a combination of unique identifiers for the devices and an access control list.

Devices 301-306 may include, but are not limited to, personal devices such as eyewear 301, fitness band 302, smart watch 303, ring 304, bracelet 305, and/or smartphone 306. In some embodiments, these devices could have actionable controllers, such as a button, virtual button, a motion sensor for detecting gestures, finger print reader, and/or the like for conducting various commands, such as confirming payment, confirming a purchase, activating a payment application, and/or the like. As technology progresses and enables more wearable objects to contain microcomputers with communication capabilities, these items may also be used in a similar manner as devices 301-306. Some examples may include clothing, hats, key chains, shoes, wallets, belt buckles, earrings, necklaces, cuff links, pins or brooches, tattoos, keycards, embedded medical devices, biomechanical devices, and/or the like.

Some and/or all of devices 301-306 may contain applications and hardware to provide a variety of services, which may include, but are not limited to, biometric monitoring, location services, input mechanisms and/or the like. Biometric monitoring may be conducted by one or more of devices 301-306 through a combination of on or more heartbeat monitors, electromyography (EMG) monitors, brainwave scanners, heat scanners, bioelectrical impedance (BIA) monitors, gait and/or motion detection using accelerometers and/or gyroscopes, pedometers, and/or the like.

In some embodiments, devices 301-306 may cooperate to assess risk, provided payment authorization, and/or activate/deactivate functionality and/or the device as part of a security measure. For example, each device may be given a payment authorization level based on the number of devices that are currently connected to the personal area network. A device separated from the personal area network may have some or all of its functionality deactivated, such as the ability to use it as a payment device.

In some examples, one or more devices may check biometrics to assess an authorization level. Fitness tracker 302, watch 303, and ring 304 may have heart rate monitors, temperature monitors, accelerometers, and/or the like. Fitness tracker 302, watch 303, and ring 304 may maintain communications with each other, comparing monitor readings for anomalies. When an anomaly occurs, such as heart rates not matching for a single device, the unmatched device may automatically de-authenticate itself from being used as a payment device. In some examples, each device may have a location tracker, such as GPS, and when one or more of the devices has location readings far away from the other devices, the device may automatically de-authenticate the payment application on the device.

In some embodiments, one or more devices 301-306 may be in communications with a remote server (not shown), such as third-party device 108 and/or network based security system 110 of FIG. 1, through a network, such as the internet. Devices 301-306 may report monitoring data (e.g. location, biometrics, connected devices in the personal area network, etc.) that is being collected by the remote server. In some embodiments, the reported data may be encrypted before being sent and/or collected. In some embodiments, the reported data may be partial readings or partial data samples of the monitoring data for security purposes. In this manner, the device and server may synchronize in terms of which portion of a sensor reading is going to be used for authentication such that a hacker would not only need the sensor reading, but also the synchronizing system used by the device and/or server. The remote server may then analyze the collected data from each device to determine whether there are any anomalies and, in response, change payment authorization levels, device functionality, and/or the like. For example, a device with too many anomalies (e.g. mismatching location, device connectivity, mismatching biometric readings) may have its payment capability completely deactivated. In some embodiments, losing connection to a remote server may cause de-authentication. In some embodiments, devices without internet connections may send information regarding biometrics collected, devices it is connected to as part of a personal network, location information, and/or the like as part of its payment information to a merchant. The merchant may relay the payment information to the remote server for use as authentication, for example information regarding biometrics collected, devices it is connected to as part of a personal network, location information, and the like may be compared to historical collections of such information for congruency. The remote system may then authorize the transaction and/or deny the transaction based on the level of congruency. In some embodiments, users may be able to override de-authorized devices by providing one or more security measures, such as providing a fingerprint, password, and/or the like.

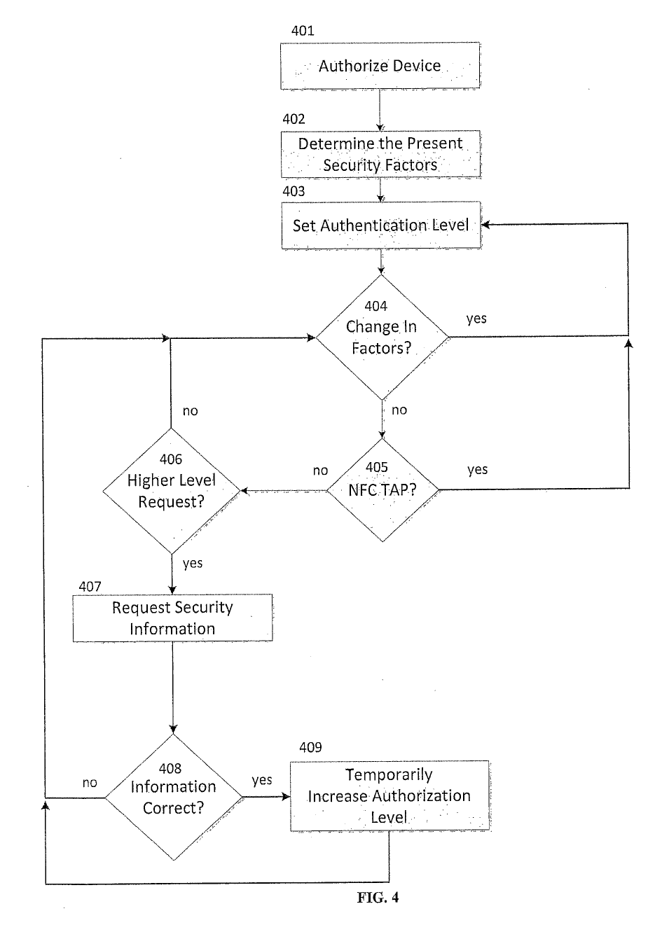

FIG. 4 is a flow diagram illustrating a process 400 implementing cooperative device security according to an embodiment. Note that one or more of the steps described herein may be combined, omitted, or performed in a different sequence as desired.

At 401, a device may be configured as being authorized as a payment device. A user may configure the device as a payment device by providing payment information, such as account information, credit card numbers, and/or the like. In some embodiments, the device may be configured as a payment device by registering the device with a payment provider. The registration may be held or stored on a server, such as third-party device 108 and/or network-based security system 110 of FIG. 1. In some embodiments, the device may be configured and/or authorized as a payment device through a NFC tap from a master device. In some examples, payment, account, device identifiers, user identifiers, security keys and/or codes, and/or device configurations may be transferred to the device from the master device through the NFC tap.

In some embodiments, payment authorizations may have levels. For example, a higher level may increase a threshold transfer value that a device is authorized for. The threshold may be set for a single transaction, day, week, and/or the like. For example, a first level may authorize any transaction under twenty dollars, and another level may authorize any transaction under 1,000 dollars.

In some embodiments, authorization levels may be used for irregular financial transactions (e.g. buying a car). Normal every day transactions, such as buying coffee, food, and gas, may not require an authorization level.

At 402, the device may determine the present security factors for setting authorization levels. Authorization levels may depend on one or more factors such as number of user devices present in a personal area network, matching biometric signals to other devices in a personal area network, matching biometric signals to historically collected biometric signals, comparison of location information of one or more devices, comparison of location information against historical location information collected, comparison of location information to a crime map, and/or the like.

For example, the device may connect with multiple devices as part of a personal area network of the user. With increasing numbers of other devices a device connects with in a user's personal area network, the higher level of authentication the device may have. This increases the difficulty for thieves to steal devices for conducting fraudulent charges. A thief may find it easy to steal a watch or a phone, but much more difficult to steal a watch, phone, glasses, hat, wallet, wristband, ring, and shoes, all which may be needed for conducting large fraudulent transactions. In some examples, the devices report connected devices to a remote server, such as third-party device 108 and/or network-based security system 110 using network 104 of FIG. 1. The remote server may count or detect the number of devices connected in the personal area network and then determine/process the authorization levels.

In some examples, the security factors may be biometric matching For example, multiple devices may have biometric sensors to monitor the biometrics of a user. One example is a heartbeat. The devices may be in communications with each other through a personal area network, and with increasing number of devices that report similar or identical heartbeats, the higher level of authorization each device may receive for conducting payments. In some embodiments, the devices may be connected with a remote server, such as such as third-party device 108 and/or network-based security system 110 using network 104 of FIG. 1. The remote server may analyze the biometric signals and accordingly set the authentication level for each device.

In some embodiments, one or more devices may record one or more different types of biometric scans over a period of time to develop a biometric signature of a user. For example, a user's gait, resting heart rate, heat signature, brainwaves, and/or the like may stay within a certain standard deviation. This historical information may be stored on the device and/or on a remote server which may be encrypted for security. The device and/or server may then detect a current biometric signature of a user to set an authorization level of a device. In some instances, there may be only two authorization levels (e.g. authorized and not authorized). In some examples, when a device detects that one or more biometric signatures are off or differ by more than the standard deviation, the device may be de-activated and/or de-authorized from conducting payment transactions. In some embodiments, the authorization of a device may change based how far away or different the biometric reading from the device is from a standard deviation from historical readings.

In some examples, the security factors may be based on locations of multiple devices. For example several devices may send location information to a remote server, such as third party device 108 and/or network-based security system 110 of FIG. 1. When one or more of the devices are found to be located at a sufficient distance away from the other devices and/or a master device, that device may be deactivated and/or de-authorized from conducting payment transactions.

In some examples, location and travel history may be used to set levels of authentication. A user's general travel may be recorded over a period of time to determine certain areas/merchants visited that the user usually travels to. This information may be recorded by a device and/or a remote server using the location capabilities of the user device (e.g., GPS). The information may be used to create a virtual heat map of the general travels of the user, the hottest areas being where the user travels the most, which can be based on time of day and day of year, as travel routes may differ based on time, day of week, day of year, specific holiday, non-routine travels based on calendar information, and the like. In some embodiments, the authorization levels of a device may change as the location of the device travels further away from the historic travel histories or expected travel routes of the user. For example, every ten miles away from the normal locations of a user may reduce the authorization level by one.

In some examples, the device and/or a remote server may check the current location of a device with a crime map and edit the authorization level of the device based on the density of crime.

At 403, the authorization level of the device may be adjusted higher and/or lower depending on the current security factors and/or other changes in the system, such as an override request from a user. This may include de-authorizing and/or reauthorizing payment capabilities.

At 404, the device may check to see if any of the security factors have changed. In some examples, the change in security factors may be a disconnection of a device from a personal area network, change in a biometric reading, change in location of the user, and/or the like. When a change is detected by the device, the system may go back to process 403 to change the authentication level based on the change in factors.

If no security factors have changed, the system may determine whether an NFC tap occurred from a device, such as a master device. The NFC tap of a master device may manually activate, deactivate, or change authorizations of the device for conducting financial transactions. If an NFC tap is detected, the system may go back to process 403 to change the authentication level of the device to the authentication level caused by the NFC tap. In some examples, the user may be able to manually change authorizations of the device through an account setting on the device and or remote server instead of an NFC tap. The system, when a manual authorization change request is received, may also go to process 403 and change the authorization level of the device accordingly.

If no NFC tap or manual authentication change is received, the system may check whether the user is requesting a higher level of authorization. This may be through a user action, such as pressing a request higher authentication button on a user interface of a device. If no such request is received, the system may then check for a change in factors at 404.

As shown in FIG. 4, a loop is created between processes 404-406 that may continue until there is either a change in factors, NFC tap, and/or a request for a higher authorization level. This loop may be in any order and does not necessarily require the order shown in FIG. 4. Additionally, instead of the system and/or constantly checking for one of these processes, these processes may be interrupts that cause the system and/or device to move to the next process, such as process 403.

Referring back to process 406, if a higher request is detected, the system may move on to process 407.

At process 407, the device or system may request additional security information to increase the authorization level. The additional security information may be a username and password, just a password, a security code, finger print, face recognition, voice recognition, and/or the like.

At process 408, the device and/or system may check to see if the security information is correct. This may be conducted by comparing the security information with stored security information that the device and/or system received at a previous time from the user. If there is a match, the device may go on to process 409 and increase the authority level of the device for a temporary period of time, such as until a transaction is conducted, the next twenty four hours, and/or the like. After the temporary period of time, the device may revert to its original authentication level and move back to the 404-406 process loop.

If, on the other hand, the information is incorrect, process 409 may be skipped and the device may move on to the 404-405 process loop.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment device security system comprising:
a first device with one or more processors coupled to a memory and that executes instructions from the memory to perform the steps of:
receiving a first near field communication (NFC) communication from a master device; and
changing payment capabilities of the first device based on the first NFC communication from the master device.

2. The system of claim 1, wherein changing payment capabilities of the first device based on the first NFC communication from the master device comprises increasing a payment authorization.

3. The system of claim 1, wherein the one or more processors performs the additional steps of:
receiving a second NFC communication from the master device; and
changing payment capabilities of the first device based on the second NFC communication from the master device.

4. The method of claim 3, wherein changing payment capabilities of the first device based on the second NFC communication from the master device comprises decreasing a payment authorization.

5. The system of claim 1, wherein the one or more processors performs the additional steps of:
receiving a first biometric data from a biometric sensor;
receiving a second biometric data from a second device;
comparing the first and second biometric data; and
changing payment capabilities of the first device when the first biometric data is different from the second biometric data.

6. The system of claim 5, wherein the first and second biometric data comprises a first and second heart rate, respectively.

7. There system of claim 6, wherein the second biometric data from the second device is received through a short range wireless communication.

8. The system of claim 5, wherein the first and second biometric data comprises a first and second heat data, respectively.

9. The system of claim 5, wherein the first and second biometric data comprises a first and second bioelectrical impedance data, respectively.

10. A computer implemented method of payment device security, the method comprising:
receiving a near field communication (NFC) communication from a device; and
changing payment capabilities based on the NFC communication from the device.

11. The method of claim 10, further comprising:
receiving a first location and a second location, the second location associated with the device;
comparing the first location and second location; and
changing payment capabilities when the first and second location do not match.

12. The method of claim 11, further comprising:
receiving a user name and a password; and
changing payment capabilities based on the received user name and password.

13. The method of claim 11, further comprising:
receiving fingerprint data; and
changing payment capabilities based on the received fingerprint data.

14. The method of claim 10, further comprising:
receiving a first location;
comparing the first location to a crime map; and
changing payment capabilities based on the first location.

15. The method of claim 14, further comprising:
receiving a second location;
comparing the second location with the crime map; and
changing payment capabilities based on the second location being different than the first location,

16. A system comprising:
A first device;
A second device;
the first device receive a NFC communication from the second device; and
changing payment capabilities of the first device based on the NFC communications from the second device.

17. The system of claim 16, wherein the first device is in wireless communications with the second device and a value authorization amount for the payment capabilities of the first device decreases when the wireless communications is severed.

18. The system of claim 17, wherein the wireless communications uses a short rage wireless communication protocol.

19. The system of claim 17, comprising:
a third device in wireless communication with the first device wherein the value authorization amount is increased based on the third device being in wireless communication with the first device.

20. The system of claim 19, wherein the value authorization amount is decreased when the wireless communication between the first device and second device is severed.
